(19) United States
(12) Patent Application Publication
(10) Pub. No.: US 2007/0199417 A1
(43) Pub. Date: Aug. 30, 2007

(54) Head component of golf club head punching machine and method for fabricating the same

(76) Inventor: Chih-Shum Chen, Taoyuan City (TW)

Correspondence Address: J.C Patents, Inc., Suite 250, 4 Venture, Irvine, CA, 92618, US

(21) Appl. No.: 11/411,324

(22) Filed: Apr. 25, 2006

(30) Foreign Application Priority Data
Feb. 27, 2006 (TW) 95106516

(51) Int. Cl. B26D 1/00; B26D 7/10

(52) U.S. Cl. 83/13; 83/171

(57) ABSTRACT

A method of fabricating a head component of a golf club head is provided. The method includes following steps. First, a workpiece and a punching die are provided. Then, the workpiece and the punching die are put into a same heating environment and heated to a same temperature. Finally, the workpiece is punched by the punching die in the heating environment to form the head component of the golf club head. Further, a punching machine for fabricating the head component mentioned above is also provided. The head component made by the above method and the punching machine has the advantages of having a stable shape and no residual manufacturing stress.

### CROSS-REFERENCE TO RELATED APPLICATION

This application claims the priority benefit of Taiwan application serial no. 95106516, filed on Feb. 27, 2006. All disclosure of the Taiwan application is incorporated herein by reference.

### BACKGROUND OF THE INVENTION

1. Field of Invention

The present invention relates to a machine and method for fabricating a golf club head. More particularly, the present invention relates to a punching machine and method for fabricating a head component of a golf club head.

2. Description of Related Art

Nowadays, sports are becoming increasingly popular. Among these, golf has already become one of the most popular, and the number of people participating in golf is increasing rapidly. According to different terrains and uses, golf clubs may be divided into different kinds such as wood, iron, and putter. The head of the wood club mainly constitutes a body and one or more head components. The body has an opening for receiving the head component. The head component is a striking plate, crown, sole, or another part. The striking effect of the golf club head can be adjusted by the design of matching head components and frames of different materials.

Generally, the conventional method for fabricating the head component of a golf club head involves punching a workpiece many times with a punching machine, so as to form a head component of appropriate shape and size. Referring to FIG. 1, it is a conventional flow of fabricating the head component of the golf club head. First, a loading action is carried out (step S110). A workpiece is placed in a die, and a first punching action is performed on the workpiece (step S120). In order to easily separate the punched workpiece and the die, a release agent is usually coated between the workpiece and the die before punching. After the first punching action is finished, the release agent must be washed out (S130).

It should be noted that the conventional workpiece is usually fabricated at normal temperature. If the workpiece cannot be directly processed into the desired shape with only one step of punching, multiple steps of punching are carried out repeatedly. Therefore, referring to FIG. 1, after finishing of the step of washing out the release agent (step S130), a second punching action (step S140) and a second step of washing out the release agent (step S150) are performed on the semi-finished product. Finally, quality check and stock-in actions (step S160) are carried out. However, the conventional method for fabricating the head component has the following disadvantages. (1) A strong force is needed to punch the workpiece, so it is easy to generate residual stress on the workpiece, and the service life of the die is relatively short. (2) Multiple punching actions are needed, and a great number of man-hours and costs are consumed in fabrication. (3) A great deal of surplus material results after several punches, this causes a waste of material. These factors result in a decline in reliability and production efficiency of the product.

Further, other manners for fabricating the head component of the golf club head are provided by the conventional art, for example, forging. Specifically, for example, first a workpiece is placed into a heating furnace to be preheated. Meanwhile, a forging die is continuously heated by a high frequency heater, such that the temperature of the forging die reaches the operating temperature that is approximate to the preheating temperature of the workpiece, so as to reduce the manufacturing force applied in the subsequent forging process. Then, the preheated workpiece is taken out of the heating furnace, and placed in the forging die. The workpiece is molded by the forging die. However, in the conventional method, because the workpiece and the forging die are heated separately, when the workpiece is taken out of the heating furnace and placed in the forging die, the heat loss of the workpiece is great, and the die and the workpiece cannot be kept at the desired operating temperature. Further, in the forging process, the workpiece is stroked many times, thus resulting in a residual stress on the workpiece and affecting the reliability of product.

### SUMMARY OF THE INVENTION

An object of the present invention is to fabricate a head component of the golf club head that may be fabricated easily and has a high reliability.

Another object of the present invention is to provide a method for fabricating the head component of the golf club head, so as to eliminate the problem of residual stress resulting from the process of fabricating the head component of the gold club head.

Another object of the present invention is to provide a method for fabricating the head component of the golf club head, so as to reduce the number of punches and shorten the fabrication man-hour and cost.

Still another object of the present invention is to provide a punching machine, suitable for applying the fabricating method.

In order to achieve the above or other objects, the present invention provides a punching machine suitable for fabricating a head component of a golf club head. The punching machine comprises a heater and a punching die. The heater has a closed heating chamber. The punching die is disposed in the heating chamber. And the punching die is used to punch a workpiece in the heating chamber, so as to form the head component of the golf club head.

In an embodiment of the present invention, the punching die comprises a base and a punch. The base has a material loading region for receiving the workpiece. Further, the punch faces the material loading region and punches the workpiece.

In an embodiment of the present invention, the heater comprises an electric heater.

In an embodiment of the present invention, the material of the punching die comprises nickel-base alloy.

The present invention further provides a method for fabricating a head component of a golf club head. First, a workpiece and a punching die are provided. Then, the workpiece and the punching die are put into a same heating environment, and are heated to a same temperature. Finally, in the heating environment, the workpiece is punched by the punching die to form the head component of the golf club head.

In an embodiment of the present invention, the method for heating the workpiece and the punching die to a same temperature involves putting the workpiece and the punching die in a closed heating chamber.

In an embodiment of the present invention, the heating chamber, for example, has a constant temperature.

In an embodiment of the present invention, the workpiece and the punching die are heated to a temperature between 700° C. and 900° C.

In an embodiment of the present invention, after the workpiece is punched, removing the surplus material resulted from punching the workpiece is further comprised.

In an embodiment of the present invention, the material of the punching die is nickel-base alloy.

The present invention further provides a head component of the golf club head fabricated according to the method.

In an embodiment of the present invention, the material of the head component is, for example, titanium alloy.

According to the method of fabricating the head component of the golf club head of the present invention, after the punching die and the workpiece are put into a same heating environment and heated to a same temperature, the workpiece is punched by the punching die to fabricate the head component of the golf club head. Because the die when punching the workpiece is at the same temperature as that of the workpiece, the possible residual stress on the head component is reduced and tile number of punches is reduced, thus improving production efficiency. Further, in order to apply the method, a punching machine is further provided in the present invention. The head component made by the punching machine and method has the advantages of having a relatively high reliability, no residual manufacturing stress, and stable shape.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a conventional flow chart of fabricating a head component of a golf club head.

FIG. 2 is a flow chart of fabricating a head component of a golf club head according to the present invention.

FIG. 3 is a schematic cross-sectional view of a punching machine provided to apply the fabricating method of the present invention.

FIG. 4 is a schematic view of a head component of a golf club head fabricated by the method and punching machine of the present invention.

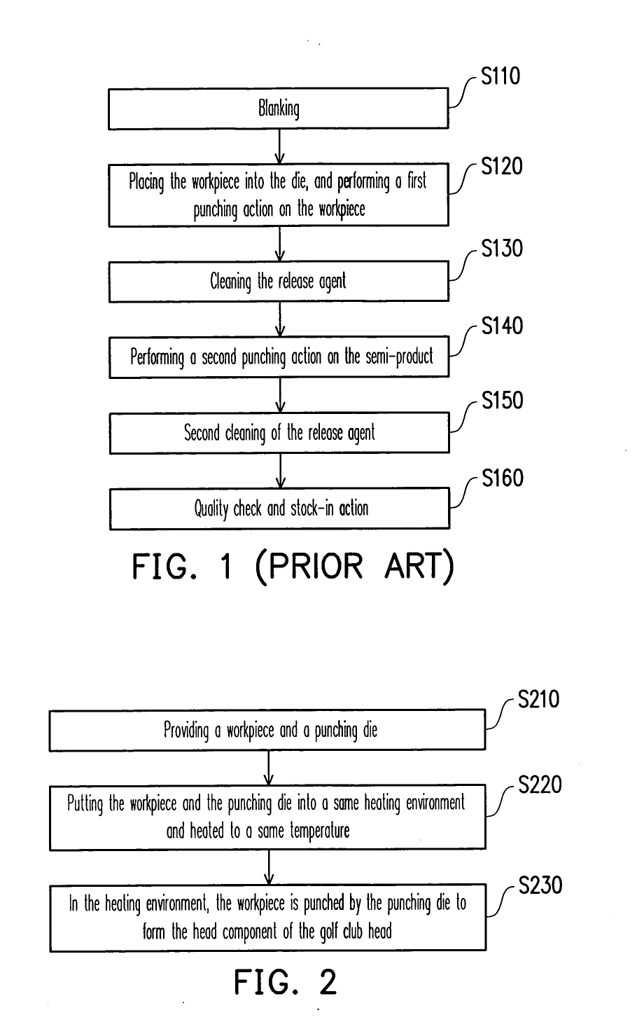

### DESCRIPTION OF EMBODIMENTS

The present invention provides a head component of a golf club head and a punching machine and method for fabricating the head component. The head component fabricated by the method and the punching machine serves as a striking plate, crown, lower plate, or another part of the golf club head.

FIG. 2 is a flow chart of fabricating a head component of a golf club head of the present invention. Referring to FIG. 2, first a workpiece and a punching die are provided (step S210), and the workpiece and the punching die are put into a same heating environment and heated to a same temperature (step S220). Because the workpiece and the punching die are heated in the same heating environment, the problem of heat loss of the conventional workpiece is eliminated. In the present embodiment, the heating environment is, for example, a closed heating chamber, and the punching die is located in the heating chamber. Thus, after being disposed on the punching die, the workpiece is heated to the required operating temperature. For example, in this embodiment, the material of the workpiece for fabricating the head component is, for example, titanium alloy. The favorable operating temperature is between 700° C. and 900° C. Therefore, the heating chamber is at a constant temperature between 700° C. and 900° C. In order to withstand the high heating temperature, the material of the punching die is, for example, nickel-base alloy.

Then, in the heating environment, the workpiece is punched by the punching die to form the head component of the golf club head (step S230). After the head component is formed, the surplus material resulted from punching is further removed. It should be noted that because the workpiece and the punching die are kept at the same temperature, when the workpiece is punched by the punching die, no residual manufacturing stress exists on the head component. In this manner, compared with the conventional head component, the head component fabricated by the method not only has favorable reliability, and also has the advantage of stable shape and will not spring back.

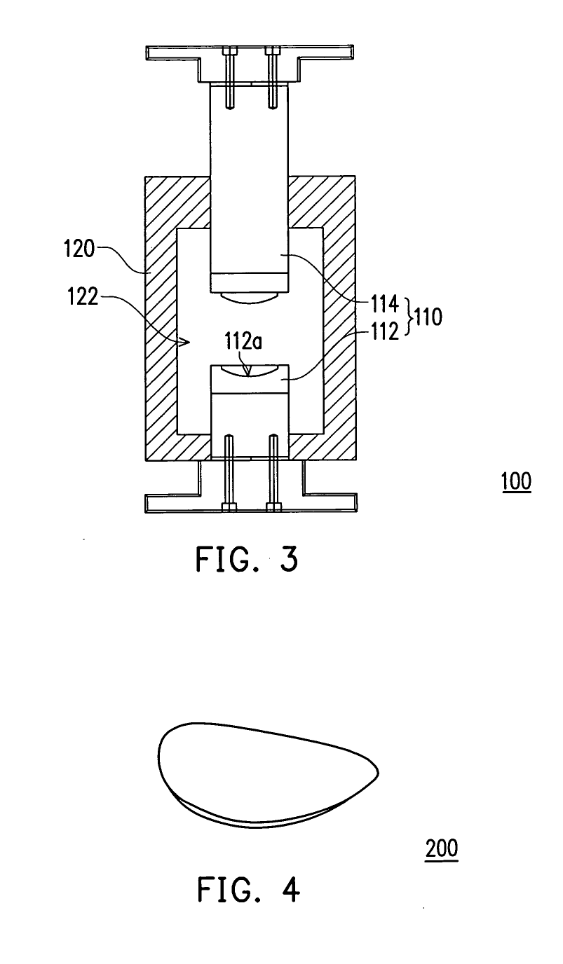

In order to apply the method, the present invention further provides a punching machine. FIG. 3 is a schematic cross-sectional view of a punching machine provided for applying the method. Referring to FIG. 3, the punching machine 100 mainly includes a heater 120 and a punching die 110. The heater 120 is provided with a closed heating chamber 122. The heating chamber 122 is the heating environment referred in the method. The heater 120 of the present embodiment is, but not limited to, for example, an electric heater.

Referring to FIG. 3, the punching die 110 is disposed in the heating chamber 122 to punch the workpiece in the heating chamber 122, so as to form a head component 200 of the golf club head (as shown in FIG. 4). The punching die 110 includes a base 112 and a punch 114. The base 112 has a material loading region 112a for receiving the workpiece. Further, the punch 114 is located above the base 112 and faces the material loading region 112a. And the punch 114 is adapted to punch the workpiece.

After the workpiece is placed in the material loading region 112a, the workpiece and the punching die 110 are heated to the same temperature in the heating chamber 122. Because the material of the workpiece of the present embodiment is, for example, titanium alloy, and the favorable plastic deformation temperature is between 700° C. and 900° C. Therefore, the temperature of the heating chamber 122 of the present embodiment must be kept at the desired operating temperature between 700° C. and 900° C.

When the workpiece is punched by the punching die 110, in order to withstand the favorable plastic deformation temperature of the workpiece and be capable of punching the workpiece, the material of the punching die 110 must be selected from the metals with absolute high-temperature strength. For example, in normal temperature, the heat treatment hardness of nickel-base alloy is HRC36. And when the nickel-base alloy is heated to 900° C., the heat treatment hardness is HRC30. Therefore, the nickel-base alloy is a favorable material for making the punching die 110.

FIG. 4 is a head component fabricated by the method and punching machine. Referring to FIG. 4, because the punching die 110 punches the workpiece at the same temperature as that of the workpiece, no residual manufacturing stress exists in the fabricated head component 200. The head component 200 does not spring back, and has the further advantage of having a stable shape and a relatively high reliability compared with the conventional head component.

Particularly, because the punching die 110 and the workpiece are in the high temperature environment between 700° C. and 900° C., compared with the conventional fabricating method, when the workpiece is punched by the punching die 110, the punching die 110 only needs to applies less force (e.g. 5 tons) to tile workpiece, and thus the workpiece can be punched into the head component 200 of the golf club head. Therefore, by using the method and punching machine 100 of the present invention to fabricate the head component 200 of the golf club head, the head component 200 is easier to be molded.

Further, the punching die 110 only punches the workpiece once to form the head component 200. The number of punches is less than that of the conventional art, thus fabrication man-hours and costs can be saved and the punching die 110 is not easily damaged. Further, due to the less number of punches, the amount of surplus material generated is little, such that the material of the workpiece and the fabricating cost can be saved.

To sum up, the head component of the golf club head and the punching machine and method for fabricating the head component of the present invention have the following advantages.

1. The punching die and the workpiece are placed in a same heating environment to be preheated, such that the problem of heat loss of the workpiece in the conventional method is eliminated.

2. The punching die punches the workpiece in the same high temperature environment. The desired force applied to the workpiece by the punching die is less than that of the conventional art. Thus, the head component is easy to be molded.

3. The punching die only punches the workpiece once to form the head component. The number of punches is less than that of the conventional art. Therefore, the fabrication man-hour and cost may be saved. Further, because punching is performed only once, surplus materials resulted from multiple punching can be avoided, thus saving the material.

4. No residual manufacturing stress exists in the head component, and the head component does not spring back. Thus, the head component has a stable shape and favorable reliability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A punching machine, suitable for fabricating a head component of a golf club head, the punching machine comprising:
a heater, having a closed heating chamber; and
a punching die, disposed in the heating chamber for punching a workpiece in the heating chamber to form the head component.

2. The punching machine as claimed in claim 1, wherein the punching die comprises:
a base, having a material loading region for carrying the workpiece; and
a punch, facing the material loading region for punching the workpiece.

3. The punching machine as claimed in claim 1, wherein the heater comprises an electric heater.

4. The punching machine as claimed in claim 1, wherein the material of the punching die comprises nickel-base alloy.

5. A method for fabricating a head component of a golf club head, comprising:
providing a workpiece and a punching die;
putting the workpiece and the punching die into a same heating environment and heating the workpiece and the punching die to a same temperature; and
punching the workpiece by the punching die in the heating environment to form the head component.

6. The method for fabricating the golf club head component as claimed in claim 5, wherein the method for heating the workpiece and the punching die to a same temperature comprises putting the workpiece and the punching die into a closed heating chamber.

7. The method for fabricating the head component of the golf club head as claimed in claim 6, wherein the heating chamber has a constant temperature.

8. The method for fabricating the head component of the golf club head as claimed in claim 5, wherein the temperature is between 700° C. and 900° C.

9. The method for fabricating the head component of the golf club head as claimed in claim 5, further comprising removing the surplus material resulted from punching after the workpiece is punched.

10. The method for fabricating the head component of the golf club head as claimed in claim 5, wherein the material of the punching die comprises nickel-base alloy.

11. A head component of the golf club head fabricated according to the method as claimed in claim 5.

12. The head component of the golf club head as claimed in claim 11, wherein the material thereof comprises titanium alloy.
